(19) United States
(12) Patent Application Publication
(10) Pub. No.: US 2023/0289856 A1
(43) Pub. Date: Sep. 14, 2023

(54) Fee Metering Device, Method and Storage Medium for Vehicle

(71) Applicant: JINAN ZHENZHEN TECHNOLOGY RESEARCH INSTITUTE, Jinan (CN)

(72) Inventor: Tingting ZHAO, Beijing (CN)

(73) Assignee: JINAN ZHENZHEN TECHNOLOGY RESEARCH INSTITUTE, Jinan (CN)

(21) Appl. No.: 18/181,512

(22) Filed: Mar. 9, 2023

(30) Foreign Application Priority Data
Mar. 13, 2022 (CN) 202210242859.8

(51) Int. Cl. G06Q 30/0283; B60W 60/00; B60W 50/14

(52) U.S. Cl. CPC G06Q 30/0284; B60W 60/00; B60W 50/14; B60W 2050/146

(57) ABSTRACT

The present disclosure provides a fee metering device, method and storage medium for a vehicle and the vehicle. The device includes a communication module that may be configured to receive at least one of a time measurement and a distance measurement, wherein the time measurement and the distance measurement represent, respectively, a time and a distance at which at least one driving assistance component of the vehicle operates the vehicle. A fee metering device of the present disclosure may comprise a fee amount metering module configured to use a rate for at least one driving assistance component together with at least one of the time measurement and distance measurement to meter the amount of fees for the at least one driving assistance component at the vehicle end.

### CROSS-REFERENCE TO RELATED APPLICATION

This application claims priority to and the benefit of Chinese Patent Application No. 202210242859.8, titled “Fee Metering Device, Method and Storage Medium for Vehicle”, filed in China National Intellectual Property Administration on Mar. 13, 2022, the entire disclosure of which is incorporated by reference herein.

### TECHNICAL FELD

This disclosure relates to fee metering for vehicles.

### BACKGROUND

The automotive field is revolutionizing. Driving assistance technology or autonomous driving technology is rapidly maturing. Software or a combination of software and hardware is replacing hardware to play a more important business role.

There have been attempts by some studies to provide users with reasonable commercial services. For example, Yosuke HATTORI from Japan had developed such a technology (which is described through the following patent family publications: PCT Patent Publication WO2017/213079A1, Chinese Patent Publication CN109478292A, US Patent Publication US2019179308A1, German Patent Publication DE112017002848T5): a device to be used by vehicle including: an information acquisition unit for acquiring information that a user has used a paid (non-free) automatic driving service; and a usage parameter calculation unit for acquiring at least one of the use time and use distance of the paid automatic driving. The vehicle further includes a vehicle-end communication unit capable of transmitting the use parameters to the management server via the network. The management server generates a usage fee for charging the automatic driving based on the usage parameters.

The current technology has defect.

### SUMMARY OF THE INVENTION

The internet-connected car was early existed, but not well developed in at least some markets. There may be other situations at the other end of the market. For example, the society highly rely on road transportation, while some roads (e.g., some interstates highways) lack high-coverage base stations, resulting in unstable network connections. Additionally, infrastructure in other markets may be inadequate, resulting in a high risk of network unavailability.

Embodiments of the present disclosure provide a fee metering device for the vehicle that allows accurate fee metering of charged driving assistance functions on the vehicle end without relying on networking between the vehicle and external object. This is advantageous because it allows users within the vehicle to keep track of fee amounts in real time (e.g., dynamic fee metering) without relying on the network.

Furthermore, the present disclosure provides users with accurate and reasonable fee metering based on time and distance measurements for the service provided by at least one driving assistance component. Users can purchase driving assistance services based precisely on their needs.

The fee metering device of the present disclosure may be arranged on a vehicle. The fee metering device of the present disclosure may comprise a communication module that may be configured to receive at least one of time measurement and distance measurement, wherein the time measurement and the distance measurement represent, respectively, the time and distance at which at least one driving assistance component of the vehicle operates the vehicle. The fee metering device of the present disclosure may comprise a fee amount metering module configured to use a fee rate data indictive of the rate for the at least one driving assistance component together with at least one of the time measurements and the distance measurement to meter the amount of fees for the at least one driving assistance component at the vehicle end. The present disclosure also provide a vehicle, the vehicle may comprising: a driving assistance system comprising at least one driving assistance component; and a fee metering device comprising: a communication module locally arranged on the vehicle, configured to receive at least one of a time measurement and a distance measurement, wherein the time measurement and the distance measurement respectively represent time and distance at which the vehicle is operated by at least one driving assistance component of the vehicle; a rate storage module locally arranged on the vehicle for storing a fee rate data, wherein the fee rate data indictive of a fee rate per unit of time and/or a fee rate per unit of distance for the at least one driving assistance component; and a fee amount metering module locally arranged on the vehicle, configured to use the fee rate data indictive of the fee rate for the at least one driving assistance component together with the at least one of the time measurements and the distance measurement to meter an amount of fees for the at least one driving assistance component. The fee metering device of the vehicle may be configured to, during the operation to the vehicle by the at least one driving assistance component, dynamically display at least one of accumulated time measurement and distance measurement to a user via a display of the vehicle. The fee metering device of the vehicle may be configured to, during the operation to the vehicle by the at least one driving assistance component, dynamically display the accumulated amount of fee to a user via a display of the vehicle. The fee metering device of the vehicle may further comprise a deduction module configured to suspend the accumulation of the amount of fee or the accumulation of the time and/or distance measurement when user intervention to the operation to the vehicle is detected. The fee metering device of the vehicle may comprise or being connected to a notification module for sending a user a notification corresponding to the start of the fee metering in response to the start of the fee metering.

Another aspect of the present disclosure provides a method of fees metering for a vehicle, comprising: receiving at least one of the time measurement and distance measurement using a communication module disposed on the vehicle, wherein the time measurement and the distance measurement respectively represents the time and distance during which the at least one driving assistance component equipped on the vehicle operates the vehicle; and usage fee amount metering module, to use a rate for the at least one driving assistance component with at least one of the time measurement and distance measurement for metering, at the vehicle end, the fee amount of the driving assistance services associated with the at least one driving assistance component.

Another aspect of the present disclosure provides a computer-readable storage medium comprising instructions which, when executed by a processor, cause the processor to perform any one of the methods according to the present disclosure.

### DESCRIPTION OF DRAWINGS

Examples will now be described, by way of non-limiting example only, with reference to the accompanying drawings, which are not necessarily to scale, in which:

FIG. 1 shows a schematic diagram of a vehicle including the fee metering device according to an embodiment of the disclosure;

FIG. 2 shows an embodiment of a fee metering device 200 according to the present disclosure;

FIG. 3 shows a system 300 according to an embodiment of the disclosure;

FIG. 4 shows a system 400 according to an embodiment of the disclosure;

FIG. 5 shows a system 500 according to an embodiment of the disclosure;

FIG. 6 shows a method 600 according to an embodiment of the disclosure;

FIG. 7 shows a computer-readable storage medium 700 according to an embodiment of the disclosure.

### DETAILED DESCRIPTION

The “driving assistance component” as described herein may provide autonomous/auto/unmanned driving functionality for at least partially (and/or completely) replacing a user in operating a vehicle. Typical driving assistance components may comprises: a driving assistance components that controls the vehicle to travel at a constant speed without needing the user to operate the accelerator and/or deceleration pedals; a driving assistance components that controls the vehicle to accelerate/decelerate following the front vehicle's acceleration/deceleration without needing the user to operate the accelerator and/or deceleration pedals; a driving assistance components that controls the vehicle to change lanes and/or overtake front vehicle without needing the user to operate the steering mechanism; a driving assistance components that controls the vehicle to travel, for example, along a determined path or toward a determined destination, without needing any user's operation at all (in this case, the driving assistance can also be called “autonomous driving”, “autonomous driving”, “full self-driving” or “unmanned driving”).

The driving assistance components of the present disclosure may comprise any components that implements driving assistance functions. The driving assistance component may comprise a memory storing instructions to implement driving assistance function. The driving assistance component may comprise a processor that executes instructions to implement driving assistance function. The driving assistance components may comprise various sensors for sensing environmental parameters, such as radar, Lidar, vision sensors, and the like. The driving assistance components may comprise a control mechanism for controlling acceleration, deceleration, steering, lights, etc. of the vehicle and other components or parts associated with driving. The driving assistance components may also comprise software or any combination of hardware and software for implementing the service of at least partially (and/or completely) replacing a user in operating a vehicle.

The fee metering device of the present disclosure may be implemented as a device having processing capabilities and instructions for implementing the fee metering device, wherein the device having processing capabilities and the memory storing the instructions for implementing the fee metering device may share processing or storage resources with other functional components of the vehicle. Therefore, the fee metering device of the present disclosure may also be referred to as a “fee metering unit”. The fee metering unit may comprise a processing module for processing instructions. The fee metering unit may comprise a storage module for storing instructions. The fee metering unit may comprise a communication module to receive or transmit data related to fee metering.

Therefore, the fee metering device or the fee metering unit of the present disclosure is not necessarily to be (but, also, can be) a physics device dedicated to metering the fee for the driving assistance service. Rather, the fee metering device or the fee metering unit of the present disclosure may be a virtual device or virtual unit that is physically integrated with other functional components.

The fee metering device (or called fee metering unit) of the present disclosure, calculates the fee for the driving assistance service related to at least one driving assistance component based on at least one of a time measure and a distance measure. The time measurement and the distance measurement herein represent, respectively, the time and distance during which the at least one driving assistance component equipped with the vehicle operates the vehicle. Therefore, the fee metering provided by the present disclosure may be referred to as “fee metering based on measurement”. Compared with the fee estimated based on the start point and end point or the occupied time of assisted driving, the fees metering based on the time measurement and/or distance measurement of the present disclosure provides more accurate and reasonable billing and allows to start the billing for the user to begin and/or end the billing for the assisted driving service at any time during the journey. In addition, the technical solution of the present disclosure allows the user to know the amount of the fee in real time at the vehicle end without relying on the network, thus providing an improved user experience.

The fee metering device or fee metering unit of the present disclosure may be referred to as a “local fee metering device” or “local fee metering unit”, because it is locally arranged on the vehicle and thus can “locally” meter the fee for the driving assistance components without needing to connect the vehicle to an object out of the vehicle via the network.

The “charged driving assistance function” in the present disclosure refers to a non-free driving assistance service. That is, if the user uses the driving assistance service, he/she should pay money (e.g., legal tender) and/or virtual currency (e.g., bitcoin), or equivalent things.

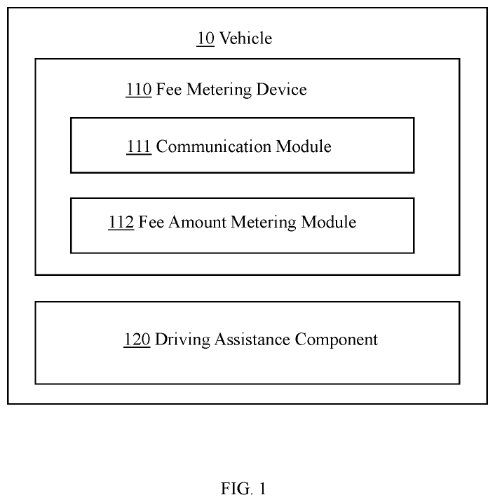

FIG. 1 shows a schematic diagram of a vehicle 10 comprising a fee metering device 110 according to an embodiment of the disclosure.

As shown in FIG. 1, the fee metering device 110 and at least one driving assistance component 120 are arranged on the vehicle 10. The fee metering device 110 may comprise a communication module 111 for receiving at least one of a time measurement and a distance measurement. The fee metering device 110 may comprise a fee amount metering module 112. The fee amount metering module 112 may obtain a rate for the at least one driving assistance component 120 and use the rate with at least one of a time measurement and a distance measurement to obtain the fee amount for the driving assistance service associated with the at least one driving assistance component 120.

The vehicle 10 may be any type of vehicle such as (but not limited to), a single-wheeled vehicle, a two-wheeled vehicle, a three-wheeled vehicle, a four-wheeled vehicle, a vehicle with more than four wheels, an aircraft, an amphibious vehicle, an amphibious vehicle tools, underwater vehicles, and vehicles that can penetrate Earth's atmosphere (such as starships), and so on.

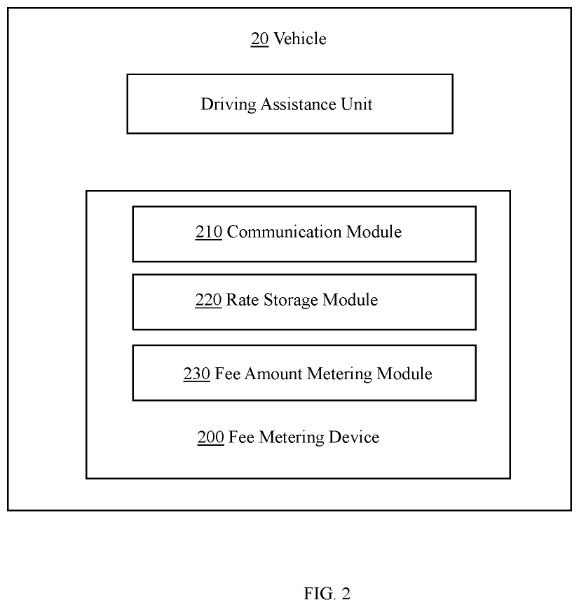

FIG. 2 shows an embodiment of an expense metering device 200 according to the present disclosure.

As shown in FIG. 2, the fee metering device 200 may be arranged on a vehicle 20. The fee metering device 200 may comprise a communication module 210, a fee rate storage module 220 and a fee amount metering module 230.

The communication module 210 may be configured to receive data or information, such as from a driving assistance unit (or driving assistance component). In one example, the received data or information may comprise at least one of the time measurement and distance measurement described above. In one example, the received data or information may comprise an indication that the driving assistance component is beginning to operate the vehicle at least in part for replacing the user.

The fee metering device 200 may comprise a time measurement receiving module and/or a distance measurement receiving module. For example, the communication module 210 of the fee metering device 200 may be designed to include a time measurement receiving sub-module 211 to receive a time measurement, which is used together with the rate to calculate the amount of the fee. The time measurement corresponds to a count of time that the vehicle was operated by the charged driving assistance service. For example, the communication module 210 of the fee metering device 200 may be designed to comprise a distance measurement receiving sub-module 212 to receive the distance measurement that should be used together with the rate to calculate the amount of the fee. The distance measurement corresponds to a count of the distance that the vehicle is operated by the charged driving assistance service.

As described above with reference to the fee metering device, the fee metering device in which the rate storage module 220 is comprised may be a local functional unit arranged locally on the vehicle. Therefore, the rate storage module 220 can also be referred to as a “local rate storage module”, which is used for storing the rate for at least one driving assistance service associated with at least one driving assistance component. The fee rate data may be indicative of a fee rate per unit of time and/or a fee rate per unit of distance for at least one assisted driving service.

The fee amount metering module 230 may obtain the fee rate from the rate storage module 220 and obtain the amount of the service fee based on the obtained rate and time and/or distance measurements. The fee amount metering module 230 may also be a local functional unit arranged locally on the vehicle.

It is well known that rate-based metering of fee amounts can be implemented in a number of ways. Or say, various formulas may be utilized for rate-based fee amount measurement. It can be understood that the present disclosure is not intended to limit the use of a specific formula to calculate the fee of the assisted driving service. Rather, obtaining the service fee amount based on the rate time and/or distance measurements disclosed herein comprising any fee metering method that increases the fee amount as (either or both of) the time measurement and the distance measurement increase.

According to an embodiment of the present disclosure, the fee metering device 200 may further comprises a fee amount storage module for storing one or more metered fee amounts.

In one embodiment, the charged assisted driving service corresponds to fully autonomous driving. Wherein the fully autonomous driving is a service in which the vehicle automatically (autonomously) drives the vehicle to the destination without user intervention, based on the destination entered by the user.

According to an embodiment, metering the amount of fee may comprises firstly accumulate time and/or distance measurements during the service and then calculate the amount of the fee at the end of the service. For example, a parameter measurement accumulator may be employed that may identify one or more time periods as time periods for which a driving assistance fee should be charged and/or identify one or more distance measurements as distance measurements for which a driving assistance fee should be charged. Accordingly, the parameter measurement accumulator may accumulate, over time, a total time measurement and/or a total distance measurement for which a fee should be charged. The time and/or distance parameters accumulated by the parameter accumulator may be stored in memory. The stored accumulated parameters may comprise the fee of one or more service segments, wherein the one or more service segments indicate a plurality of segments that the charged service is alternately used and not used during the user's travel. Finally, the total time measurement and/or the distance measurement can be used with the rate to calculate the amount of the fee. In one example, information associated with the accumulated time and/or distance measurement may be presented to the user, e.g., via a display screen communicatively coupled to the fee metering device. In other words, the time and/or distance measurement based on which the total fee being calculated may be presented to the user, wherein the time and/or distance measurement is dynamic (e.g., increases as the service proceedings). In one example, during operation of the vehicle by at least one driving assistance component, dynamic cumulative measurements (time and/or distance measurements) may be presented to the user along with rates for the services being used but not to present the amount of fee, for example, via a display connected to or included in the fee metering device. In one example, the amount of fee for the driving assistance service may be calculated in response to the ending of the charged driving assistance service (e.g., the user manually exits the service, or the driving assistance unit automatically exits the service). In one example, the amount of the service fee may be presented to the user in response to the ending of the service.

The above-described embodiment of accumulating time and/or distance measurements has a unique advantage because it provides factors for strictly calculate the amount of fee per time and/or distance measurement by using a parameter measurement accumulator, or say, by accumulating the actual time and/or distance measurement. For example, no matter the charged driving assistance service alternates between being used and being exited or being always used (never exited) during the journey, an accurate fee amount can be obtained at the end of the journey. For example, the above billing scheme may provide fair adjustment of the fee according to the predefined rules without the user feeling distrustful of the fee change, because the amount of the fee is not provided to the user in real time during the journey. The predefined rules can be any rules that allow adjustment of the amount of the final service fee. For example, the predefined rules may comprise rounding rules (e.g., if the service fee is $12.76, the final charge may be $13.00). For example, the predefined rules can stipulate that the service from point A to point B should be charged according to the nominal distance of 25 kilometers on the electronic map, but the actual driving distance is 27 kilometers (caused by the vehicle detour or not driving in a straight line), if the rule of accumulating charges strictly by distance, the user may be presented with a fee amount corresponding to 27 kilometers, but at the end of the service the fee amount changes to correspond to 25 kilometers. In addition, the fee amount may also vary in an increasing manner.

Thus, according to one embodiment of the present disclosure, the time and/or distance measurement may be accumulated and used together with the rate stored in local memory to calculate the amount of fee at the end of the service. Furthermore, an embodiment may adjust the final fee amount according to predefined rules (e.g., via an additional fee amount adjustment module), and present the adjusted fee amount to the user.

Alternatively, according to one embodiment of the present disclosure, the fee amount may be accumulated in real time according to the measured time and/or distance measurement. In one example, the amount of the accumulated fee may be presented to the user in real time, e.g., via a display. The unique exemplary advantage of this embodiment is that the user can know in real time the amount of the service fee incurred during the service period.

In one embodiment, the fee metering device 200 may comprise a deduction module that may deduct from the accumulated fee measurement or the time and/or distance measurement corresponding to at least one driving assistance component not controlling the vehicle due to user intervention. For example, the deduction module may be configured to suspend the accrual of fees or the accrual of time and/or distance measurements when user intervention in operation of the vehicle is detected. Additionally, the fee metering device 200 may be configured to continue the accrual of fee or the accrual of the time and/or distance measurement when the at least one driving assistance component resumes operating the vehicle (when the user exits operation of the vehicle).

In one embodiment, the fee metering device 200 may comprise or be connected to a notification module for sending a notification to the user corresponding to the start of fee metering in response to starting to meter the fee. The notification module may e.g., correspond to a vibrator which notifies the user in the form of a vibration (e.g., via a seat vibration) in response to the start of a metered charge. The notification module may, for example, correspond to a speaker that notifies the user in audio form (e.g., emits a sound corresponding to the billing) in response to the start of the metered fee. The notification module may, for example, correspond to a display device that may notify the user in the form of light in response to the start of a metered fee (e.g., control the display device to display an icon associated with the charge). The notification module may comprise one or more of a vibrator, a speaker, and a display device.

The fee amount metering module 230 of the fee metering device 200 may begin metering the fee amount in response to at least one driving assistance component starting to operate the vehicle.

In one embodiment, the fee metering device 200 may comprise a metering start determination module for determining that at least one driving assistance component starts operating the vehicle, and determining the metering start based on the time when the at least one driving assistance component starts operating the vehicle.

In one embodiment, the communication module 210 of the fee metering device 200 may receive an indication 211 that at least one driving assistance component begins to operate the vehicle at least partially on behalf of the user. In response to receipt of the indication 211, the fee amount metering module 230 may begin accumulating time and/or distance measurements at the fee amount metering module 230 or accumulate a fee amount based on the received time and/or distance measurement.

In one example, the indication 211 may be information generated by the driving assistance component to indicate that it is beginning to operate the vehicle at least in part on behalf of the user. The driving assistance component (e.g., via its communication module) may send the indication 211 to the communication module 210 of the fee metering module 230.

For example, the indication 211 may be a field compiled with a predefined specification that can be interpreted at the fee metering device 200. The fee metering device 200 may further receive (e.g., also via the communication module 210) the time and/or distance measurement, and may start accumulating the received time and/or distance measurement or accumulate the fee amount based on the received time and/or distance measurement in response to receiving the indication 211. In addition, the fee metering device 200 may also receive an indication that accumulating measurements or accumulating fees should be stopped, so as to stop the accumulation associated with the fee metering, or in other words, complete the fee metering.

Furthermore, there are other ways for the fee metering device 200 to start accumulating fees. For example, a monitoring module can be arranged for monitoring whether at least one driving assistance component is functioning. The monitoring module may be a module independent of both the driving assistance component and the fee metering device 200. If it is determined that at least one driving assistance component that should be charged is enabled to operate the vehicle, the monitoring module may be signaling the fee metering device 200 to begin the process of metering the fee.

According to an embodiment of the present disclosure, the fee metering process of the fee metering device 200 may be started by using a trigger event for the at least one driving assistance component. For example, the fee metering device 200 may use the received at least one of the time and distance measurements together with the rate to meter the fee at the vehicle end, in response to a trigger mechanism for the at least one driving assistance component being triggered by the user.

According to an embodiment of the present disclosure, at least one driving assistance component may receive an instruction from a user via a trigger mechanism to activate the driving assistance component to operate the vehicle. In one example, the at least one driving assistance component can operate the vehicle in response to the trigger mechanism being activated by the user. In one example, the trigger mechanism may be part of a driving assistance component.

The trigger mechanism may be any mechanism capable of receiving a trigger from a user, including (but not limited to) at least one of a joystick, a physical button, and a virtual button displayed via a screen.

According to an embodiment of the present disclosure, the trigger mechanism may comprise or be coupled to a splitter (or multiplexer) for splitting a single signal from the trigger mechanism indicating that the trigger mechanism is activated by the user into at least: (1) a driving assistance service enablement signal, associated with enabling at least one driving assistance; and (2) a fee metering signal, associated with starting the fee metering.

According to an embodiment of the present disclosure, at least one driving assistance component may begin operating the vehicle based on the driving assistance service enablement signal from the trigger mechanism via the splitter. The fee metering device 200 may initiate the metering in response to receiving the fee metering signal from the trigger mechanism via the splitter.

Embodiments comprising the splitter described above may provide more accurate metering because it enables triggering of driving assistance services and metering of charges to start at the same moment (or substantially the same moment). Furthermore, such embodiments use a single trigger operation from the user to trigger both the charged driving assistance service and the charge metering process. Thus, such implementations provide solutions that save processing resources and even hardware costs.

According to an embodiment of the present disclosure, the communication module 210 of the fee metering device 200 may receive the fee metering signal (which is generated by the trigger mechanism together with the driving assistance service enablement signal for activating the driving assistance component) via the splitter coupled to the at least one driving assistance component. In response to receiving the fee metering signal, the fee amount metering module 230 of the fee metering device 200 may begin accumulating the time and/or distance measurement for use in calculating the fee amount or may accumulate the amount of fee based on the received time and/or distance measurements.

Accordingly, embodiments of the present disclosure provide a system capable of metering the fee amount for the charged driving assistance service.

According to an embodiment of the present disclosure, a single trigger mechanism may be used to trigger two or more driving assistance services (or driving assistance components) corresponding to different charging policies.

According to an embodiment of the present disclosure, the trigger mechanism may be configured to receive a first trigger for starting a first driving assistance service with a first charging policy and/or a second trigger for starting a second driving assistance service with a second charging policy from the user. One of the charging policies may correspond to a free policy, that is, the user can use the corresponding driving assistance service (or driving assistance component) without paying. Another one of the charging policies may correspond to the charging policy that meters the fee based on the time and/or distance measurements described in connection with the devices or systems herein.

According to an embodiment of the present disclosure, different charging policies may correspond to different charging amounts. For example, the first driving assistance service may be charged at US$0.1 per kilometer, while the second driving assistance service may be charged at US$0.2 per kilometer.

According to an embodiment of the present disclosure, the triggering gestures for the first trigger and the second trigger may be the same but may be different in at least one of triggering duration, triggering force, and triggering times within a predefined time period. That is to say, the trigger mechanism may be configured to receive triggers having the same triggering gestures as different triggers (first trigger and second trigger respectively corresponding to the first charging strategy and the second charging strategy), wherein the first trigger and the second trigger are different at least in one of: triggering duration, triggering force, and triggering times within a predefined time period.

The triggering gesture refers to the gesture inputted by the user to the trigger mechanism to trigger the driving assistance function, and may comprise, for example, one or more of pressing a button, sliding a scroll wheel, flipping a lever, contacting or pressing an input to a touch-sensitive sensor. The triggering gestures corresponding to the first trigger and the second trigger may be a same triggering gesture.

It should be noted that the above gestures are only exemplary, and the triggering gestures may vary according to the type and principle of the trigger mechanism. Further, the trigger mechanisms of the present disclosure may comprise any mechanism capable of enabling driving assistance and shall not being limited to the above mentioned mechanisms.

Triggering duration refers to a measurement of how long a user makes a trigger input to a trigger mechanism. For example, in instances where the trigger mechanism is a button, the first trigger may correspond to a first press duration and the second trigger may correspond to a second press duration that is different in duration from the first press duration. For example, in an example where the trigger mechanism is a scroll wheel, the first trigger may correspond to a first scrolling duration, and the second trigger may correspond to a second scrolling duration different from the first scrolling duration. For example, in an example where the trigger mechanism is a toggle lever, the first trigger may correspond to a first toggle duration, and the second trigger may correspond to a second toggle duration that is different from the first toggle duration. For example, in an example where the trigger mechanism is a touch-sensitive sensor, the first trigger may correspond to a first touch or press duration, and the second trigger may correspond to a second touch or press duration that is different from the first touch or press duration.

Trigger force refers to a measurement of the amount of force (e.g., in Newtons) with which a user makes a trigger input to a trigger mechanism. For example, in an example where the triggering gesture is a press (e.g., the trigger mechanism is a button or a touch-sensitive sensor), a first press force may correspond to the first trigger, and a second press force with a second measurement of force may correspond to the second trigger. In the example where the triggering gesture is a toggle lever, a first force for pulling or pushing the lever may correspond to a first trigger and a second force (different in magnitude with the first pulling or pushing) for pulling or pushing the lever may correspond to the second trigger.

The triggering times within the predefined time period refers to the number of firing the trigger by the user within the predefined time period. For example, in the button example, the firing action may correspond to a first trigger if the user presses the button once within the predefined time period, and may corresponds to a second trigger if the user presses the button twice within the predefined time period. The same explanation applies to other examples. For example, the number of times the lever is toggled within a predefined time can be used as the identification of the first trigger or the second trigger.

It should be noted that the descriptions of “first trigger” and “second trigger” herein are only used to represent different triggers associated with assisted driving services with different charging policies. There are not necessarily only two triggers, and there may be more that depending on the number of driving assistances with different charging policies, for example, a third trigger and a fourth trigger.

By receiving the trigger with the same triggering gesture as the first trigger and the second trigger corresponding to the first charging strategy and the second charging strategy respectively, and using at least one of triggering duration, triggering force, and triggering times within a predefined time period to recognize different triggers can save the arrangement of the trigger structure (for example, no need to set multiple buttons for different types of driving assistance functions), and at the same time, the user's operation can be simplified (for example, no need to switch between different trigger mechanisms switch).

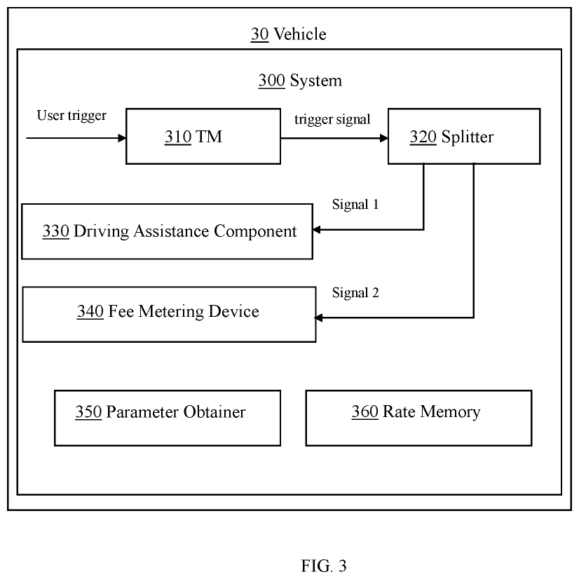

FIG. 3 shows a system 300 according to an embodiment of the disclosure.

As shown in FIG. 3, system 300 may be arranged on the vehicle 30. System 300 may comprise a trigger mechanism 310, a splitter 320, a driving assistance component 330, and a fee metering device 340.

Trigger mechanism (TM) 310 may receive a trigger from a user. For example, trigger mechanism 310 may generate the trigger signal, e.g., in response to a user's trigger event. For example, the trigger signal can be sent to the splitter 320. For example, at the splitter 320, the trigger signal may be split into multiple signals, and the multiple signals may at least comprises the driving assistance service enablement signal and the fee metering signal, for example, signal 1 and signal 2 as shown in FIG. 3.

The splitter of the present disclosure may refer to any mechanism that converts a trigger signal generated via a user's trigger action for use in initiating at least one driving assistance service and initiating metering amount of fees, which may comprise one or any combination of software, hardware and firmware. For example, splitter 320 may receive and process a trigger signal from trigger mechanism 310 to generate the signal to activate at least one driving assistance service and a signal to initiate the fee metering.

The system 300 may further comprise a parameter obtainer 350 for obtaining at least one of a time measurement and a distance measurement based on which the usage fee of the driving assistance service is to be calculated.

The system 300 may further comprises a rate memory 360 for storing at least one of a rate per unit of time and a rate per unit of distance.

The system 300 may calculate the fee that should be charged based on at least one of the fee per unit time and the fee per unit distance stored in the rate memory 360 and at least one of the measured time measurement and distance measurement.

In one embodiment, the system 300 may comprise a memory storing instructions, and a processor that, when executing the instructions, may: receive a trigger signal from a trigger mechanism; split the trigger signal into a driving assistance service enablement signal and a fee metering signal; send the driving assistance service enablement signal to the driving assistance component to cause the driving assistance component to begin at least partially controlling the vehicle, and sending the fee metering signal to the fee metering component to begin metering the fee for the driving assistance; obtain at least one of a rate per unit of service time and a rate per service distance for the driving assistance service; obtain at least one of a time measurement and a distance measurement for the driving assistance service; and calculate, based on the at least one of fee rate per unit of service time and the fee rate per service distance as well as at least one of the at least one of the time measurement and the distance measurement, the fee amount for the driving assistance service.

It will be appreciated that the above-described elements of system 300 may be arranged on-board the vehicle to allow local metering of at least one driving assistance fee on the vehicle without relying on the vehicle's link to an external object.

It can be understood that although the disclosed fee metering device 200 or system 300 is able to meter the fee for the driving assistance function locally on the vehicle without relying on the communication between the vehicle and the external object via the network, the fee metering device 200 or system 300 of the present disclosure may be capable of communicating via a network with objects external to the vehicle.

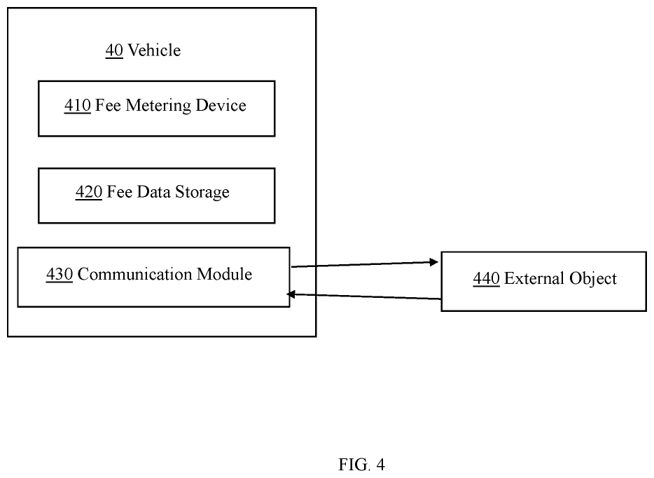

FIG. 4 shows a system 400 according to the present disclosure.

As shown in FIG. 4, the system 400 may comprise a fee metering device 410, a fee data storage 420, and a communication module 430 arranged on the vehicle 40.

The fee metering device 410 may comprise any aspects of embodiment, example, of the fee metering device or system described above, such as the fee metering device 200 or system 300 described with reference to FIG. 2 or FIG. 3. The fee metering device 410 is able to meter the fee amount for at least one driving assistance at the vehicle end and store the metered fee amount in the fee data memory 420.

The communication module 430 may communicate with an external object 440 external to the vehicle such that the external obtains from the vehicle the amount of fee for the at least one driving assistance service. The external object 440 may comprise, for example, a server that may be associated with the user's account to deduct the amount of fee as metered at the vehicle end from the balance account.

The communication module 430 may comprise a communication baseband for long-range communication such as a cellular network.

In one embodiment, the communication module 430 may be configured to query about an available external object 440 via the network (e.g., the cellular network), and if a response is received indicating that there is an external object available (e.g., can be successfully connected via the network connection), the data representing the amount of fee for the driving assistance service can be sent to the external object 440.

In one embodiment, the communication module 430 may be configured to receive data indicative of a user's account balance from the external object 440 via the network. In one example, paid driving assistance services may be determined to be disabled at the vehicle end if the data indicates that the user's account balance is less than a predefined amount.

In one embodiment, the external object 440 may determine that one driving assistance service is indicated to be disabled at the vehicle end based on the user's account balance, and send information associated with disabling the at least one driving assistance service to the vehicle via the network.

The vehicle's “networking capabilities” may not be available. For example, some vehicles may not have networking capabilities. Networking capabilities can be costly to the vehicle. This may be caused by the cost of communication hardware (such as chips), etc., or even the cost of intellectual property rights. For example, the networking capabilities of some vehicles are given up by users. For example, due to the failure of vehicle manufacturers to provide connected car services with a reasonable pricing strategy. Or, vehicle manufacturers are defeated by mobile terminals in terms of service (application) diversification, making users prefer to use their own mobile terminals, and lack of dependence on the equipment onboard the vehicle. In conclusion, many users abandon network-connection services shortly after purchasing the vehicle, especially in cost-sensitive markets. However, it may be desirable to provide charged driving assistance services on vehicles where networking functionality is not available. It should be noted that “networking functionality” herein refers to connecting the vehicle to the Internet (e.g., the World Wide Web), e.g., via a cellular network. Vehicles that do not have “network function” or those vehicles “network-connection function” are not available may have short-range communication functions such as short-range wireless communication and wired connection communication, especially communication with devices carried inside the vehicle.

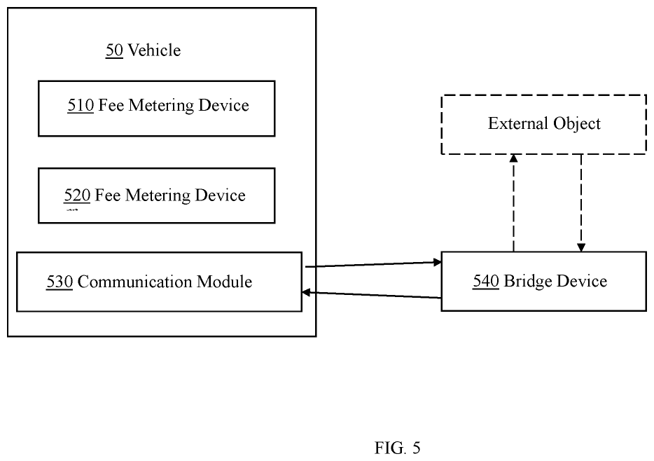

FIG. 5 shows a system 500 according to an embodiment of the disclosure.

As shown in FIG. 5, the system 500 may comprise a fee metering device 510, a fee data storage 520, and a communication module 530 arranged on a vehicle 500.

The fee metering device 510 may comprise any aspects of embodiment, example, of the fee metering device or system described above, such as the fee metering device 200 or system 300 described with reference to FIG. 2 or FIG. 3. The fee metering device 410 can meter the amount of fee for at least one assisted driving at one end of the vehicle. The amount of the metered fee for the charged assisted driving service may be stored in the fee data storage 520.

The communication module 530 may comprise a short-range communication module for short-range communication, such as a bluetooth module, a zigbee module, a WiFi communication module, a near-field communication NFC module, and a wired connection module (such as a USB connection interface).

As used herein, “short-range communication” refers to communication between two or more nodes in close proximity, for example, communication between communication module 530 of system 500 and a device located within a vehicle. This “short-range communication” may be network communication without access to the Internet (World Wide Web), and “short-range communication” may be communication in which two or more nodes are directly connected without being supported by a base station (or a cellular network formed by a base station). In contrast, “telecommunication” can be a communication service usually provided by a mobile network provider, “telecommunication” can be a communication supported by a base station (or a cellular network formed by a base station), and “telecommunication” can be access to the Internet (World Wide Web) communication.

The communication module 530 may be configured to send to and/or receive from a bridge device 540 (e.g., via a short-range communication module) data associated with the charged driving assistance service, e.g., data on the fee amount.

The bridge device 540 may comprise a portable electronic device. The bridge device 540 may comprise at least one of: a smart phone, a wearable device, a laptop, a tablet. The bridge device 540 may comprise an application program APP (for example, by using programmable code to control the processor) associated with the charged driving assistance service.

In one embodiment, the bridge device 540 may have telecommunication capabilities, e.g., may comprise a telecommunication module. The bridge device 540 may be connected to the communication module 530 of the system 500 via short-range communication, and receive data associated with the charged assisted driving service (e.g., the amount of the service fee) from the communication module 530, for example, the data is being relayed via the bridge device 540. For example, bridge device 540 may transmit the data received on bridge device 540 via telecommunication to the external object, e.g., object remote from the vehicle. For example, the external object may use this data to process user accounts, for example, to perform debit operations or generate bills.

In one embodiment, the bridge device 540 can locally store user account data and applications that process the user account, so that the processing related to charging operations can be performed at the bridge device 540, such as performing debit operations or generating bills. The system 500 may receive data associated with a user account (e.g., account balance, outstanding bills, etc.) that is processed at bridge device 540 from the bridge device 540 and determine whether the charged driving assistance service can be provided to the user based on the data associated with the user account.

In one embodiment, the system 500 may receive data from bridge device 540 via communication module 530 indicating whether a charged driving assistance service is available. For the sake of brevity, the data indicating whether the charged driving assistance service is available is referred as “lock data”. The lock data may indicate the locked state and/or unlocked state of the charged driving assistance feature. The locked state corresponds to that the driving assistance feature is not available or cannot be activated. The unlocked state corresponds to that the driving assistance feature is available or can be activated.

In one embodiment, system 500 may determine whether to activate the at least one charged driving assistance service based on lock data received from bridge device 540. For example, if the system 500 receives lock data corresponding to a locked state from the bridge device 540, the at least one charged driving assistance service may be locked or not unlocked. A locked driving assistance service cannot provide corresponding driving assistance operations in response to a user's request. For example, if system 500 receives lock data corresponding to an unlocked state from bridge device 540, the at least one charged driving assistance service may be unlocked or not to be locked. The unlocked driving assistance service may provide corresponding driving assistance operations in response to a user's request.

In one embodiment, the lock data may be generated at the external object other than the vehicle. The lock data generated at the external object may be transmitted to bridge device 540 via telecommunication, such as the World Wide Web supported by a base-station based cellular network. The bridge device 540 may then transmit to the system 500 via short-range communication (e.g., a Bluetooth connection).

In one embodiment, lock data may be generated at bridge device 540 and transmitted to system 500 via short-range communication (e.g., a Bluetooth connection).

Therefore, the bridge device 540 may act as a processing terminal that allows the data related to the fee and availability of the driving assistance (charged with fees) for the vehicle to be processed “offline”, i.e. not via the Internet, in which case the bridge device 540 may be referred to as offline bridge device. Moreover, the bridge device 540 may act as a relay device for relaying data between the vehicle 50 and external object regarding the fee and availability of the driving assistance for the vehicle. This example provides metering and settlement of fees for premium driving assistance services for vehicles that are not capable of connecting to the Internet. And therefore, the external object in FIG. 5 is shown as dashed lines, because the external object may be optional according to the implementation of the bridge device.

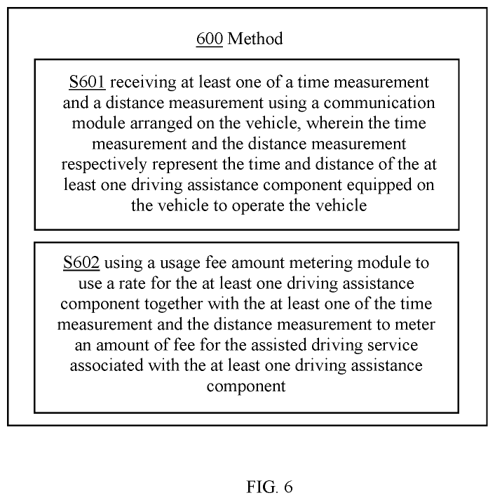

FIG. 6 shows a method 600 according to an embodiment of the disclosure.

As shown in FIG. 6, the method 600 may comprise: S601 receiving at least one of a time measurement and a distance measurement using a communication module arranged on the vehicle, wherein the time measurement and the distance measurement respectively represent the time and distance of the at least one driving assistance component equipped on the vehicle to operate the vehicle; and S602 using a usage fee amount metering module to use a rate for the at least one driving assistance component together with the at least one of the time measurement and the distance measurement to meter an amount of fee for the assisted driving service associated with the at least one driving assistance component.

The methods of the present disclosure may further comprise methods corresponding to the above-described examples, embodiments, and products. The method of the present disclosure may comprise all the steps or implementations that can be realized by the products and products described above. For brevity, repetitions of various embodiments in conjunction with methods are omitted.

For example, the methods of the present disclosure may comprise methods corresponding to processing steps/implementations described with reference to above parts of system 300, system 400, and/or system 500.

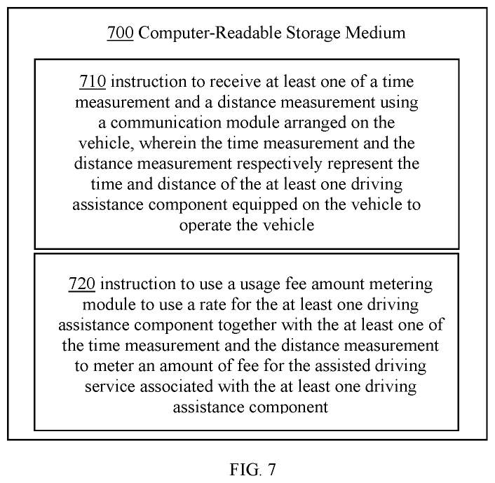

FIG. 7 shows a computer-readable storage medium 700 according to an embodiment of the disclosure.

As shown in FIG. 7, the computer-readable storage medium 700 comprises instruction 710 to receive at least one of a time measurement and a distance measurement using a communication module arranged on the vehicle, wherein the time measurement and the distance measurement respectively represent the time and distance of the at least one driving assistance component equipped on the vehicle to operate the vehicle; and instruction 720 to use a usage fee amount metering module to use a rate for the at least one driving assistance component together with the at least one of the time measurement and the distance measurement to meter an amount of fee for the assisted driving service associated with the at least one driving assistance component.

The instructions of the computer-readable storage medium 700, when executed by the processor, may cause the processor to perform any one of the methods according to the present disclosure.

The computer-readable storage medium of the present disclosure may further comprise instructions corresponding to the various examples, embodiments, and products described above. The computer-readable storage medium of the present disclosure may comprise instructions for implementing all the steps or embodiments that can be realized by the above-described articles of manufacture or products. For brevity, repetition of various embodiments in connection with computer-readable storage media has been omitted.

Unless otherwise stated or clearly contradicted, various examples and embodiments described in conjunction with methods, articles of manufacture (such as devices or systems) and computer-readable media of the present disclosure may be combined with each other, and such combinations are included within the disclosure scope of the present disclosure. For the sake of brevity, all combinable examples are omitted here.

It is well known that this description only describes a limited number of examples, and these examples are not intended to limit the scope of the technical solutions claimed in this application. Various changes and modifications to the illustrated examples may be made by those skilled in the art in light of the present disclosure. The appended claims cover all such modifications and changes as are within the true spirit and scope of this invention.

1. A vehicle, comprising:
a driving assistance system comprising at least one driving assistance component; and
a fee metering device, comprising:
a communication module locally arranged on the vehicle, configured to receive at least one of a time measurement and a distance measurement, wherein the time measurement and the distance measurement respectively represent time and distance at which the vehicle is operated by at least one driving assistance component of the vehicle;
a rate storage module locally arranged on the vehicle for storing a fee rate data, wherein the fee rate data indicative of a fee rate per unit of time and/or a fee rate per unit of distance for the at least one driving assistance component; and
a fee amount metering module locally arranged on the vehicle, configured to meter an amount of fees for the at least one driving assistance component by using the fee rate data indicative of the fee rate for the at least one driving assistance component together with the at least one of the time measurements and the distance measurement.

2. The vehicle according to claim 1, wherein the fee metering device is configured to, during the operation to the vehicle by the at least one driving assistance component, dynamically display at least one of accumulated time measurement and distance measurement to a user via a display of the vehicle.

3. The vehicle according to claim 1, wherein the fee metering device is configured to, during the operation to the vehicle by the at least one driving assistance component, dynamically display the accumulated amount of fee to a user via a display of the vehicle.

4. The vehicle according to claim 1, wherein the fee metering device further comprise a deduction module configured to suspend the accumulation of the amount of fee or the accumulation of the time and/or distance measurement when user intervention to the operation to the vehicle is detected.

5. The vehicle according to claim 1, wherein the fee metering device comprise or being connected to a notification module for sending a user a notification corresponding to the start of the fee metering in response to the start of the fee metering.

6. A fee metering device for a vehicle, comprising:
a communication module, configured to receive at least one of a time measurement and a distance measurement, wherein the time measurement and the distance measurement respectively represent time and distance at which the vehicle is operated by at least one driving assistance component of the vehicle;
a rate storage module storing a fee rate data, wherein the fee rate data indicative of a fee rate per unit of time and/or a fee rate per unit of distance for the at least one driving assistance component; and
a fee amount metering module, configured to meter an amount of fees for the at least one driving assistance component, by using the fee rate data indicative of the fee rate for the at least one driving assistance component together with the at least one of the time measurements and the distance measurement;
wherein, the communication module, the rate storage module and the fee amount metering module are locally arranged on the vehicle.

7. The fee metering device according to claim 6, configured to, during the operation to the vehicle by the at least one driving assistance component, dynamically display at least one of accumulated time measurement and distance measurement to a user via a display.

8. The fee metering device according to claim 6, configured to, during the operation to the vehicle by the at least one driving assistance component, dynamically display the accumulated amount of fee to a user via a display.

9. The fee metering device according to claim 6, further comprising a deduction module configured to suspend the accumulation of the amount of fee or the accumulation of the time and/or distance measurement when user intervention to the operation to the vehicle is detected.

10. The fee metering device according to claim 6, comprise or being connected to a notification module for sending a user a notification corresponding to the start of the fee metering in response to the start of the fee metering.

11. A fees metering method for a vehicle, comprising:
using a communication module locally arranged on the vehicle to receive at least one of a time measurement and a distance measurement, wherein the time measurement and the distance measurement respectively represent time and distance at which the vehicle is operated by at least one driving assistance component of the vehicle;
receiving, from a rate storage module locally arranged on the vehicle, a fee rate data indicative of a fee rate per unit of time and/or a fee rate per unit of distance for the at least one driving assistance component; and
using a fee amount metering module locally arranged on the vehicle to meter an amount of fees for the at least one driving assistance component, by using the fee rate data indicative of the fee rate for the at least one driving assistance component together with the at least one of the time measurements and the distance measurement.

12. The fee metering method of claim 11, further comprising, during the operation to the vehicle by the at least one driving assistance component, dynamically displaying at least one of accumulated time measurement and distance measurement to a user via a display.

13. The fees metering method of claim 11, further comprising, during the operation to the vehicle by the at least one driving assistance component, dynamically displaying the accumulated amount of fee to a user via a display.

14. The fee metering method according to claim 11, further comprising suspending the accumulation of the amount of fee or the accumulation of the time and/or distance measurement when user intervention to the operation to the vehicle is detected.

15. A non-transitory computer-readable storage medium comprising instructions which, when executed by a processor, cause the processor to perform the method of claim 11.
